(19) United States
(12) Patent Application Publication
(10) Pub. No.: US 2026/0371304 A1
(43) Pub. Date: Nov. 19, 2026

(54) METHODS FOR INDICATING MOBILE IAB NODE POSITIONING MEASUREMENTS IN THE NETWORK

(71) Applicant: TELEFONAKTIEBOLAGET LM ERICSSON (PUBL), Stockholm (SE)

(72) Inventors: RITESH SHREEVASTAV, UPPLANDS VÄSBY (SE); MOHAMMED YAZID LYAZIDI, LONDON (GB); FILIP BARAC, HUDDINGE (SE)

(21) Appl. No.: 19/102,120

(22) PCT Filed: Aug. 8, 2023
(86) PCT No.: PCT/IB2023/058005

§ 371 Date: Feb. 7, 2025

Related U.S. Application Data
(60) Provisional application No. 63/395,941, filed on Aug. 8, 2022.

(51) Int. Cl. H04W 64/00

(52) U.S. Cl. CPC H04W 64/003

(57) ABSTRACT

There is provided a method performed by a first network node. The method comprises: sending a first message to a second network node, for requesting a type of network node of the second network node; in response to the first message, receiving an indication of the type of network node of the second network node, the type of network node of the second network node being a mobile network node; sending a second message to the second network node, for requesting location information of the second network node, based on the type of network node; and in response to the second message, receiving an indication of the location information from the second network node.

### RELATED APPLICATIONS

This application claims the benefits of priority of U.S. Provisional Patent Application No. 63/395,941, entitled “Methods for indicating Mobile IAB node positioning measurements in the network” and filed at the United States Patent and Trademark Office (USPTO) on Aug. 8, 2022.

### TECHNICAL FIELD

This application generally relates to wireless communications and more specifically to indicating mobile IAB node positioning measurements.

### BACKGROUND

### Positioning Architecture

Positioning has been a topic in Long Term Evolution (LTE) standardization since Release (Rel.) 9 of the 3rd Generation Partnership Project (3GPP). The primary objective was initially to fulfill regulatory requirements for emergency call positioning but other use cases like positioning for Industrial Internet of Things (I-IoT) are becoming important. Positioning in New Radio (NR) is supported, e.g., by the architecture shown in FIG. 1. The Location Management Function (LMF) is the location node in NR. There are also interactions between the location node and the gNodeB (gNB) via the NR Positioning Protocol A (NRPPa). The interactions between the gNB and the device is supported via the Radio Resource Control (RRC) protocol, while the location node interfaces with the User Equipment (UE) via the LTE Positioning Protocol (LPP). LPP is common to both NR and LTE. It will be appreciated that while FIG. 1 shows both a gNB and a new generation (ng)-eNB, both may not always be present. Further, when both the gNB and the ng-eNB are present, the NG-C is generally only present for one of them. The NG-Radio Access Network (RAN) can comprise a gNB and a ng-eNB or the NG-RAN can only comprise one of them. Furthermore, the gNB can have several Transmission Reception Points (TRPs) and the ng-eNB can have several Transmission Points (TPs). NR supports RAT dependent positioning methods, such as Downlink (DL)-Time Difference of Arrival (TDOA), Multi-Round Trip Time (RTT), Uplink (UL)-TDOA, DL-Angle of Departure (AoD), UL-AoA, NR-Enhanced Cell IDentity (ECID), etc.

### Integrated Access and Backhaul (IAB) Overview

Fifth Generation (5G) networks are being designed and deployed considering a dense deployment of small cells in order to simultaneously serve more UEs with higher throughput and lower delay. However, building from scratch a completely new infrastructure is costly and takes time. Deploying a wireless backhaul is then envisioned to be an economically and technically viable approach to enable flexible and dense network.

This solution was standardized in 3GPP release 16, under the term Integrated Access and Backhaul (IAB), to support wireless relaying in NG-RAN and has continued in Rel. 17.

### IAB Architecture

IAB is based on the Centralized Unit (CU)-Distributed Unit (DU) split that was standardized in Rel. 15. The CU is in charge of the radio resource control (RRC) and the packet data convergence (PCDP) protocol, whereas the DU is in charge of the radio link control (RLC) and media access control (MAC). The F1 interface connects the CU and the DU. The CU-DU split facilitates separate physical CU and DU, while also allowing a single CU to be connected to multiple DUs. FIG. 2 shows the basic architecture of IAB.

The architecture of FIG. 2 comprises a single IAB donor connected to the core network. The IAB donor serves three direct IAB child nodes through two collocated DUs at the donor for wireless backhauling. The center IAB node in turn serves two IAB nodes through wireless backhaul. All IAB nodes in the figure backhauls traffic both related to UEs connected to it, and other backhaul traffic from downstream IAB nodes.

More specifically, the main components of the IAB architecture are:
IAB Node: A node that allows wireless access to the UEs while also backhauling the traffic to other nodes. The IAB node comprises a DU that provides access to connected UEs. The node also comprises a mobile termination (MT) that connects to other IAB nodes or donors in the uplink direction for backhaul.
IAB Donor: A node that provides UEs an interface to the core network and wireless functionality to other IAB-nodes to backhaul their traffic to the core network.

In Rel. 16, IAB was standardized with basic support for multi-hop multi-path backhaul for directed acyclic graph (DAG) topology, no mesh-based topology was supported. Rel. 16 also supports Quality of Service (QoS) prioritization of backhaul traffic and flexible resource usage between access and backhaul. Current discussions in Rel. 17 are on topology enhancements for IAB with partial migration of IAB nodes for Radio Link Failure (RLF) recovery and load balancing.

In Rel. 18, it is expected that the different RAN groups will work towards enhancing functionality of IAB through:
focus on mobile-IAB/vehicle mounted relays (VMR) providing 5G coverage enhancement to onboard and surrounding UEs; and
smart repeaters that build on LTE-repeaters.

The initial use cases for mobile-IAB/VMR are expected to be based on 3GPP Technical Report (TR) 22.839.

One of the main use cases of mobile IAB cell is to serve the UEs which are residing in the vehicle with the vehicle mounted relay. Other relevant use cases for mobile IABs involve a mobile/nomadic IAB network node mounted on a vehicle that provides extended coverage. This involves scenarios where additional coverage is required during special events like concerts, during disasters. The nomadic IAB node provides access to surrounding UEs while the backhaul traffic from the nomadic IAB node is then transmitted wirelessly either with the help of IAB donors or Non-terrestrial networks (NTN). A nomadic IAB node also reduces or even eliminates signal strength loss due to vehicle penetration for UEs that are present in the vehicles.

Advantages of Mobile IAB are: reducing/eliminating the vehicle penetration loss (specially at high frequency), and reducing/eliminating group handover.

### SUMMARY

There currently exist certain challenge(s). SA2 is currently investigating in TR 23.700-05 V0.3.0 the architectural enhancements for vehicle mounted relays or mobile IAB nodes in Rel. 18. A key issue is how to support location-based services for UEs accessing the 5G system (5GS) and served by a mobile IAB node, i.e., an IAB node that changes its geographical position. As a note, an IAB node can be a gNB/network node.

In this context, it is not clear that the location procedures defined in TS 38.305 can be reused without modification or limitation, as a mobile IAB node hosting a TRP may provide different measurement results, in terms of latency and accuracy, compared to a static TRP. For example, some positioning methods may not be usable in this case, or the accuracy improvement methods defined in the positioning 3GPP Rel. 17 version may no longer be valid.

Furthermore, a solution in the TR mentions that the LMF has to request and obtain the positioning capabilities of the mobile IAB node as well as the position of the IAB node. However, currently the provision to support positioning is only based upon the assumption that the TRPs are static (i.e. fixed at known location). But with the gNB-DU being mobile, it begs the question: how would the mobile DU (e.g. TRPs) be part of positioning estimate (part of the Assistance data to facilitate in PRS transmission and UL-SRS measurement, for example)?

Certain aspects of the disclosure and their embodiments may provide solutions to these or other challenges.

This disclosure provides support for mobile TRP capability signaling as a new definition in TS 38.305, as well as new code points in the NRPPa and F1AP messages between the gNB-CU and LMF, and the gNB-DU and gNB-CU, respectively. New indicators for the position of the mobile IAB as a new type of measurement result are added in the specific NRPPa and F1AP messages, for the exchange of positioning measurements.

For example, a new codepoint or information element (IE) for mobile TRP capability can be added in the F1AP and NRPPA TRP INFORMATION RESPONSE message. Upon reception of such an indication, the LMF can prepare the recommendation for PRS transmission, positioning with SRS and/or measurement request procedure accordingly.

A new codepoint or IE for mobile TRP positioning can be added in the F1AP and NRPPA MEASUREMENT RESPONSE message. Upon reception of such an indication, the LMF can use it for UE's positioning location estimation.

A mechanism for the LMF to inquire the gNB/AMF about the IDs of the UEs onboard the vehicle hosting the mobile IAB node is also provided.

According to one aspect, there is provided a method performed by a first network node. The method comprises: sending a first message to a second network node, for requesting a type of network node of the second network node; in response to the first message, receiving an indication of the type of network node of the second network node, the type of network node of the second network node being a mobile network node; sending a second message to the second network node, for requesting location information of the second network node, based on the type of network node; and in response to the second message, receiving an indication of the location information from the second network node.

There is provided another method performed by a first network node. The method comprises: receiving a first message for requesting a type of network node, from a second network node; in response to the first message, sending an indication of the type of network node of the first network node to the second network node, the type of network node of the first network node being a mobile network node; receiving a second message for requesting location information of the first network node, based on the type of network node; and in response to the second message, sending an indication of the location information to the second network node.

Certain embodiments may provide one or more of the following technical advantage(s).

Thanks to the solutions herein, the LMF is aware of which TRPs hosted by the gNB/IAB node can be mobile and take appropriate actions (e.g. include the mobile TRP into the positioning assistance data or not). By knowing the IDs of the UEs onboard a vehicle hosting the mobile IAB node, when obtaining the position of one of the UEs, the LMF implicitly knows the position of the other UEs onboard and, thus, it does not have to run a separate positioning procedure for each UE.

### BRIEF DESCRIPTION OF THE DRAWINGS

Exemplary embodiments will be described in more detail with reference to the following figures, in which:

FIG. 1 illustrates an example of a positioning architecture in NR, where NG-RAN LCS protocols are also shown.

FIG. 2 illustrates an example of an IAB basic architecture.

FIG. 3 illustrates an example of a signaling diagram between a TRP and LMF according to some embodiments.

FIG. 4 illustrates an example of a flow chart of a method in a first network node, according to some embodiments.

FIG. 5 illustrates an example of a flow chart of a method in a first network node, according to some embodiments.

FIG. 6 shows an example of a communication system, according to an embodiment.

FIG. 7 shows a schematic diagram of a UE, according to an embodiment.

FIG. 8 shows a schematic diagram of a network node, according to an embodiment.

FIG. 9 illustrates a block diagram illustrating a virtualization environment.

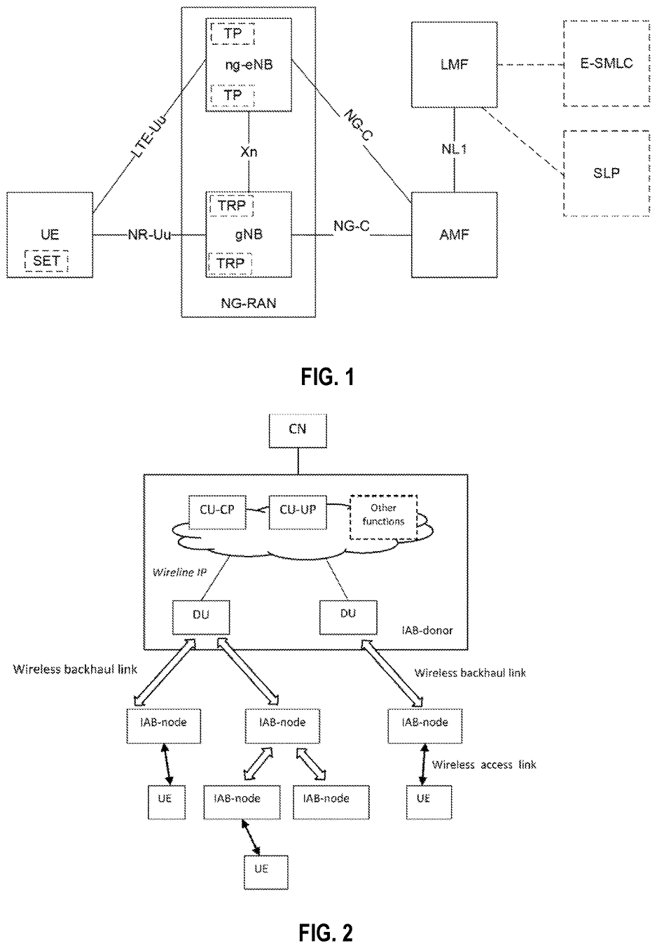

### DETAILED DESCRIPTION

Some of the embodiments contemplated herein will now be described more fully with reference to the accompanying drawings. Embodiments are provided by way of examples to convey the scope of the subject matter to those skilled in the art.

### LMF Decisions

For positioning, more than 3 TRPs at distinct coordinates are required. The mobile IAB as such is used for coverage extension and to improve the passenger's UE Quality of experience in the vehicle (e.g. bus/train, etc.). It can happen that there are not many static TRPs available and the LMF may need to either include the mobile IAB or exclude the mobile IAB. If the mobile IAB is excluded, the LMF may further use hybrid or other positioning methods, such as Global navigation satellite system (GNSS) Sensor based methods.

The decision to include/exclude the mobile IAB can depend on how accurately the mobile IAB position can be estimated, for example, if it is synchronized with Global Positioning System (GPS) with regards to timing estimations and/or if it is moving with some constant acceleration.

For example, the LMF can obtain the mobile IAB positioning measurements and estimates the positioning error. If the error is within an acceptable limit, it instructs the mobile IAB-DU (TRP(s)) to transmit PRS or perform RTOA measurement.

The LMF may also obtain the sensor-based measurements, such as via an accelerometer, and other measurements, such as velocity, and also decide whether the mobile IAB should be included or excluded from the position measurements, even when the mobile IAB is capable of taking part or perform positioning measurements.

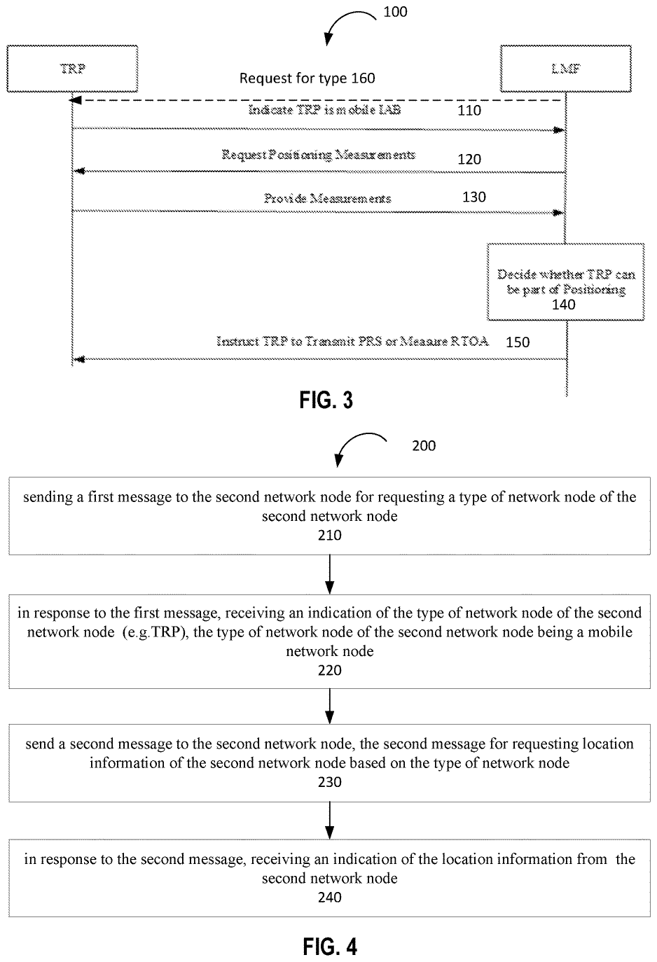

Turning to FIG. 3, an example of a method (or a mechanism) 100 will described, whereby the LMF may decide whether to:
include or exclude a mobile TRP as part of the assistance data for positioning; and/or
include or exclude a mobile TRP to perform UL SRS measurements (Relative Time of Arrival (RTOA) measurements). The method 100 comprises:

In step 110, the TRP sends a message to the LMF, indicating to the LMF that it is a mobile IAB node.

In step 120, the LMF sends a message to the TRP, with a request for positioning measurements, for example.

Upon receipt of the request, the TRP performs the requested measurements. And in step 130, the TRP provides/sends the measurements to the LMF.

Upon receipt of the measurements from the TRP, the LMF decides whether the TRP can be part of the positioning assistance data, in step 140. For example, the LMF can estimate the positioning error. If the error is within an acceptable limit, then the LMF decides to include the TRP to be part of the assistance data for positioning. In this case, in step 150, the LMF instructs the TRP to transmit PRS or measure/perform RTOA measurements.

Before sending the message in step 110, the TRP may receive a message from the LMF requesting the type of the TRP (mobile or not), in step 160 (this step may be optional). This message may be sent using NRPPa signalling. The message can be a TRP INFORMATION REQUEST message. Also, this message may be sent using F1AP signalling.

### NRPPa Signalling

In one example, upon receiving the TRP INFORMATION REQUEST message from the LMF with a request for TRP types (e.g step 160), the gNB sends a response message indicating which of its hosted TRPs is mobile. This new indication can be as a new codepoint within the TRP Type IE or as separate indication in the TRP Information IE.

In another example, the gNB can further indicate a list of cells or tracking areas where the mobile TRP may move to. This list of cells can be configured in advance or updated by Operation Administration and Maintenance (AOM).

Without loss of generality, an example to TS 38.455 is provided below, with the TRP type extended to cover the mobile TRP (or mobile IAB or mobile gNB):

The TRP Information IE contains information for one TRP within an NG-RAN node.

| | | | IE Type and | Semantics | | Assigned |
|---|---|---|---|---|---|---|
| IE/Group Name | Presence | Range | Reference | Description | Criticality | Criticality |
| TRP ID | M | | 9.2.24 | | — | |
| TRP Information Type | | 1 . . . | | | — | |
| | | <maxnoTRPInfoTypes> | | | | |
| >CHOICE TRP | M | | | | — | |
| Information Item | | | | | | |
| >>NR PCI | M | | INTEGER | NR Physical | — | |
| | | | (0 . . . 1007) | Cell ID | | |
| >>NR CGI | M | | 9.2.9 | | — | |
| >>NR ARFCN | M | | INTEGER | | — | |
| | | | (0 . . . 3279165) | | | |
| >>PRS Configuration | M | | 9.2.44 | | — | |
| >>SSB Information | M | | 9.2.54 | | — | |
| >>SFN Initialisation | M | | Relative Time | | — | |
| Time | | | 1900 | | | |
| | | | 9.2.36 | | | |
| >>Spatial Direction | M | | 9.2.45 | | — | |
| Information | | | | | | |
| >>Geographical | M | | 9.2.46 | | — | |
| Coordinates | | | | | | |
| >>TRP type | M | | ENUMERATED | TS 38.305 [18] | YES | reject |
| | | | (prs-only-tp, srs- | | | |
| | | | only-rp, tp, rp, | | | |
| | | | trp . . . , mobile trp, | | | |
| | | | mobile-IAB, | | | |
| | | | mobile gNB) | | | |
| >>On-demand PRS | M | | 9.2.65 | | YES | reject |
| TRP Information | | | | | | |
| >>TRP Tx TEG | M | | 9.2.79 | | YES | reject |
| Association | | | | | | |
| >>TRP Beam | M | | 9.2.82 | | YES | reject |
| Antenna Information | | | | | | |

| Range bound | Explanation |
|---|---|
| maxnoTRPInfoTypes | Maximum no of TRP information types that can be requested |
| | and reported with one message. Value is 64. |

Below is an example of an extract from TS 38.305 with the new definition added for mobile TRP:

### 3.1 DEFINITIONS

For the purposes of the present document, the terms and definitions given in TR 21.905 [1] and the following apply. A term defined in the present document takes precedence over the definition of the same term, if any, in TR 21.905 [1].

As used in this document, the suffixes “-based” and “-assisted” refer respectively to the node that is responsible for making the positioning calculation (and which may also provide measurements) and a node that provides measurements (but which does not make the positioning calculation). Thus, an operation in which measurements are provided by the UE to the LMF to be used in the computation of a position estimate is described as “UE-assisted” (and could also be called “LMF-based”), while one in which the UE computes its own position is described as “UE-based”.
Transmission Point (TP): A set of geographically co-located transmit antennas (e.g. antenna array (with one or more antenna elements)) for one cell, part of one cell or one DL-PRS-only TP. Transmission Points can include base station (ng-eNB or gNB) antennas, remote radio heads, a remote antenna of a base station, an antenna of a DL-PRS-only TP, etc. One cell can include one or multiple transmission points. For a homogeneous deployment, each transmission point may correspond to one cell.
Reception Point (RP): A set of geographically co-located receive antennas (e.g. antenna array (with one or more antenna elements)) for one cell, part of one cell or one UL-SRS-only RP. Reception Points can include base station (ng-eNB or gNB) antennas, remote radio heads, a remote antenna of a base station, an antenna of a UL-SRS-only RP, etc. One cell can include one or multiple reception points. For a homogeneous deployment, each reception point may correspond to one cell.
PRS-only TP: A TP which only transmits PRS signals and is not associated with a cell.
SRS-only RP: An RP which only receives SRS signals and is not associated with a cell. Transmission-Reception Point (TRP): A set of geographically co-located antennas (e.g. antenna array (with one or more antenna elements)) supporting TP and/or RP functionality.
Mobile TRP: A TRP whose location and/or cell ID may change. The TRP is part of mobile IAB-DU. This also implies that a separate Mobile IAB-MT exist which can perform UE positioning. The TRP may be a part of mobile gNB.

The information on the mobile TRP capability with a list of cells and tracking areas where the TRP can move to can be encoded as below in NRPPA:

The TRP Information IE contains information for one TRP within an NG-RAN node.

| | | | IE Type and | Semantics | | Assigned |
|---|---|---|---|---|---|---|
| IE/Group Name | Presence | Range | Reference | Description | Criticality | Criticality |
| TRP ID | M | | 9.2.24 | | — | |
| TRP Information Type | | 1 . . . | | | — | |
| | | <maxnoTRPInfoTypes> | | | | |
| >CHOICE TRP | M | | | | — | |
| Information Item | | | | | | |
| >>NR PCI | M | | INTEGER | NR Physical | — | |
| | | | (0 . . . 1007) | Cell ID | | |
| >>NR CGI | M | | 9.2.9 | | — | |
| >>NR ARFCN | M | | INTEGER | | — | |
| | | | (0 . . . 3279165) | | | |
| >>PRS Configuration | M | | 9.2.44 | | — | |
| >>SSB Information | M | | 9.2.54 | | — | |
| >>SFN Initialisation | M | | Relative Time | | — | |
| Time | | | 1900 | | | |
| | | | 9.2.36 | | | |
| >>Spatial Direction | M | | 9.2.45 | | — | |
| Information | | | | | | |
| >>Geographical | M | | 9.2.46 | | — | |
| Coordinates | | | | | | |
| >>TRP type | M | | ENUMERATED | TS 38.305 [18] | YES | reject |
| | | | (prs-only-tp, srs- | | | |
| | | | only-rp, tp, rp, | | | |
| | | | trp . . .) | | | |
| >>On-demand PRS | M | | 9.2.65 | | YES | reject |
| TRP Information | | | | | | |
| >>TRP Tx TEG | M | | 9.2.79 | | YES | reject |
| Association | | | | | | |
| >>TRP Beam | M | | 9.2.82 | | YES | reject |
| Antenna Information | | | | | | |
| >>TRP Mobility | O | | 9.2.X | | YES | reject |
| >>List of UEs | O | | 9.2.y | | YES | ignore |
| Onboard Mobile IAB | | | | | | |

| Range bound | Explanation |
|---|---|
| maxnoTRPInfoTypes | Maximum no of TRP information types that can be requested |
| | and reported with one message. Value is 64. |

This IE contains TRP mobility information.

| IE/Group | | | IE Type and | Semantics |
|---|---|---|---|---|
| Name | Presence | Range | Reference | Description |
| List of cells | | 1 . . . | | |
| | | <maxnoCells> | | |
| >Cell ID | M | | NR CGI | The Cell ID where the |
| | | | 9.2.9 | mobile TRP can move to. |
| >TAC | M | | TAC | Tracking Area Code of |
| | | | 9.2.11 | the serving cell |

| Range bound | Explanation |
|---|---|
| maxnoCells | Maximum no of cells in an NG-RAN node. |
| | Value is 1638. |

This IE contains the IDs of UEs onboard and served by a mobile IAB node.

| IE/Group | | | IE Type and | Semantics |
|---|---|---|---|---|
| Name | Presence | Range | Reference | Description |
| List of UEs | | 1 . . . | | |
| | | <maxnoUEs> | | |
| >UE ID | M | | | The ID of a UE served |
| | | | | by mobile IAB node. |

| Range bound | Explanation |
|---|---|
| maxnoof UEs | Maximum no of UEs that can be |
| | served by a mobile IAB node. |
| | Value is 1638. |

In one example, upon receiving an indication from the gNB that a TRP is mobile (in step 110 of FIG. 3), the LMF can exclude some positioning methods, when the mobile TRP is used for positioning.

In one example, the NG-RAN/gNB can signal the mobile TRP location or coordinates (X, Y, Z) as a new positioning measurement during the MEASUREMENT RESPONSE message (step 130 of FIG. 3) in the TRP Measurement Result IE.

This information element contains the measurement result.

| | | | IE Type and | Semantics | | Assigned |
|---|---|---|---|---|---|---|
| IE/Group Name | Presence | Range | Reference | Description | Criticality | Criticality |
| Measured Result Item | | 1 . . . | | | | |
| | | <maxnoPosMeas> | | | | |
| >CHOICE Measured | M | | | | | |
| Results Value | | | | | | |
| >>UL Angle of | M | | 9.2.38 | | — | |
| Arrival | | | | | | |
| >>UL SRS-RSRP | M | | INTEGER | | — | |
| | | | (0 . . . 126) | | | |
| >>UL RTOA | M | | 9.2.39 | | — | |
| >>gNB Rx − Tx | M | | 9.2.40 | | — | |
| Time Difference | | | | | | |
| >>Z-AoA | M | | 9.2.67 | | YES | reject |
| >>Multiple UL-AoA | M | | 9.2.71 | | YES | reject |
| >>UL SRS-RSRPP | M | | 9.2.72 | | YES | reject |
| >Time Stamp | M | | 9.2.42 | | — | |
| >Measurement Quality | O | | 9.2.43 | | — | |
| >Measurement Beam | O | | 9.2.57 | | — | |
| Information | | | | | | |
| >SRS Resource type | O | | 9.2.73 | | YES | ignore |
| >ARP ID | O | | 9.2.75 | | YES | ignore |
| >LoS/NLoS Information | O | | 9.2.7 | | YES | ignore |
| >Mobile TRP/gNB | O | | 9.2.46 | | YES | ignore |
| coordinates | | | | | | |
| >>List of UEs Onboard | O | | 9.2.y | | YES | ignore |
| Mobile IAB | | | | | | |

| Range bound | Explanation |
|---|---|
| maxnoPosMeas | Maximum no. of measured quantities that can be configured and reported |
| | with one positioning measurement message. Value is 1638. |

### F1AP Signalling

In one example, supplementary information about whether the TRP is mobile TRP (e.g. step 110 of FIG. 3) is signalled over F1AP.

### 9.3.1.176 TRP Information

The TRP Information IE contains information for one TRP within a gNB-DU.

| | | | IE Type and | Semantics | | Assigned |
|---|---|---|---|---|---|---|
| IE/Group Name | Presence | Range | Reference | Description | Criticality | Criticality |
| TRP ID | M | | 9.3.1.197 | | — | |
| TRP Information Type | | 1 | | | — | |
| Response List | | | | | | |
| >TRP Information | | 1 . . . | | | — | |
| Type Response Item | | <maxnoofTRPInfoTypes> | | | | |
| >>CHOICE TRP | M | | | | — | |
| Information Type | | | | | | |
| Response Item | | | | | | |
| >>>NR PCI | M | | INTEGER | NR Physical | — | |
| | | | (0 . . . 1007) | Cell ID | | |
| >>>NR CGI | | | 9.3.1.12 | | — | |
| >>>NR ARFCN | M | | INTEGER | | — | |
| | | | (0 . . . 3279165) | | | |
| >>>PRS | M | | 9.3.1.17 | | — | |
| Configuration | | | | | | |
| >>>SSB | M | | 9.3.1.202 | | — | |
| Information | | | | | | |
| >>>SFN | M | | Relative Time | | — | |
| Initialisation | | | 1900 | | | |
| Time | | | 9.3.1.183 | | | |
| >>>Spatial | M | | 9.3.1.179 | | — | |
| Direction | | | | | | |
| Information | | | | | | |
| >>>Geographical | M | | 9.3.1.18 | | — | |
| Coordinates | | | | | | |
| >>>TRP Type | M | | ENUMERATED | TS 38.305 [42] | YES | reject |
| | | | (prs-only-tp, srs- | | | |
| | | | only-rp, tp, rp, | | | |
| | | | trp . . . mobile trp, | | | |
| | | | mobile IAB, | | | |
| | | | mobile gNB) | | | |
| >>>On-demand | M | | 9.3.1.240 | | YES | reject |
| PRS TRP | | | | | | |
| Information | | | | | | |
| >>>TRP Tx | M | | 9.3.1.252 | | YES | reject |
| TEG | | | | | | |
| Association | | | | | | |
| >>>TRP Beam | M | | 9.3.1.256 | | YES | reject |
| Antenna | | | | | | |
| Information | | | | | | |
| >>>TRP | O | | 9.3.1.X | | YES | reject |
| Mobility | | | | | | |

| Range bound | Explanation |
|---|---|
| maxnoTRPInfoTypes | Maximum no of TRP information types that can be requested |
| | and reported with one message. Value is 64. |

This IE contains TRP mobility information.

| IE/Group | | | IE Type and | Semantics |
|---|---|---|---|---|
| Name | Presence | Range | Reference | Description |
| List of cells | | 1 . . . | | |
| | | <maxnoCells> | | |
| >Cell ID | M | | NR CGI | The Cell ID where the |
| | | | 9.3.1.12 | mobile TRP can move to. |
| >TAC | M | | TAC | Tracking Area Code of |
| | | | 9.2.11 | the serving cell |

| Range bound | Explanation |
|---|---|
| maxnoCells | Maximum no of cells in a gNB-DU. |
| | Value is 1638. |

| | | | IE Type and | Semantics | | Assigned |
|---|---|---|---|---|---|---|
| IE/Group Name | Presence | Range | Reference | Description | Criticality | Criticality |
| TRP ID | M | | 9.3.1.197 | | — | |
| TRP Information Type | | 1 | | | — | |
| Response List | | | | | | |
| >TRP Information | | 1 . . . | | | — | |
| Type Response Item | | <maxnoofTRPInfoTypes> | | | | |
| >>CHOICE TRP | M | | | | — | |
| Information Type | | | | | | |
| Response Item | | | | | | |
| >>>NR PCI | M | | INTEGER | NR Physical | — | |
| | | | (0 . . . 1007) | Cell ID | | |
| >>>NR CGI | | | 9.3.1.12 | | — | |
| >>>NR | M | | INTEGER | | — | |
| ARFCN | | | (0 . . . 3279165) | | | |
| >>>PRS | M | | 9.3.1.17 | | — | |
| Configuration | | | | | | |
| >>>SSB | M | | 9.3.1.202 | | — | |
| Information | | | | | | |
| >>>SFN | M | | Relative Time | | — | |
| Initialisation | | | 1900 | | | |
| Time | | | 9.3.1.183 | | | |
| >>>Spatial | M | | 9.3.1.179 | | — | |
| Direction | | | | | | |
| Information | | | | | | |
| >>>Geographical | M | | 9.3.1.18 | | — | |
| Coordinates | | | | | | |
| >>>TRP Type | M | | ENUMERATED | TS 38.305 [42] | YES | reject |
| | | | (prs-only-tp, | | | |
| | | | srs-only-rp, tp, | | | |
| | | | rp, trp . . . , mobile | | | |
| | | | trp, mobile IAB, | | | |
| | | | mobile gNB) | | | |
| >>>On- | M | | 9.3.1.240 | | YES | reject |
| demand PRS | | | | | | |
| TRP | | | | | | |
| Information | | | | | | |
| >>>TRP Tx | M | | 9.3.1.252 | | YES | reject |
| TEG | | | | | | |
| Association | | | | | | |
| >>>TRP Beam | M | | 9.3.1.256 | | YES | reject |
| Antenna | | | | | | |
| Information | | | | | | |

In another example, the information on the mobile TRP capability with a list of cells and tracking areas where the TRP can move to can be encoded in F1AP (see also the above table).

In one example, the gNB-DU signals to gNB-CU the mobile TRP location or coordinates (X, Y, Z) as a new positioning measurement during the MEASUREMENT RESPONSE message in the TRP Measurement Result IE

### 9.3.1.16 Positioning Measurement Result

The purpose of this information element is to provide the measurement result(s).

| | | | IE Type and | Semantics | | Assigned |
|---|---|---|---|---|---|---|
| IE/Group Name | Presence | Range | Reference | Description | Criticality | Criticality |
| Positioning Measured | | 1 . . . | | | — | |
| Result Item | | <maxnoofPosMeas> | | | | |
| >CHOICE Measured | M | | | | — | |
| Results Value | | | | | | |
| >>UL Angle of | M | | 9.3.1.167 | | — | |
| Arrival | | | | | | |
| >>UL SRS-RSRP | M | | INTEGER | | — | |
| | | | (0 . . . 126) | | | |
| >>UL RTOA | M | | UL RTOA | | — | |
| | | | Measurement | | | |
| | | | 9.3.1.168 | | | |
| >>gNB Rx − Tx | M | | 9.3.1.170 | | — | |
| Time Difference | | | | | | |
| >>Zenith Angle of | M | | 9.3.1.239 | | YES | reject |
| Arrival Information | | | | | | |
| >>Multiple UL | M | | 9.3.1.245 | | YES | reject |
| AoA | | | | | | |
| >>UL SRS-RSRPP | M | | 9.3.1.246 | | YES | reject |
| >Time Stamp | M | | 9.3.1.171 | | — | |
| >Measurement Quality | O | | TRP | | — | |
| | | | Measurement | | | |
| | | | Quality | | | |
| | | | 9.3.1.172 | | | |
| >Measurement Beam | O | | 9.3.1.173 | | — | |
| Information | | | | | | |
| >ARP ID | O | | 9.3.1.244 | | YES | ignore |
| >SRS Resource type | O | | 9.3.1.247 | | YES | ignore |
| >LoS/NLoS | O | | 9.3.1.249 | | Yes | ignore |
| Information | | | | | | |
| >Mobile TRP/gNB | O | | 9.3.1.18 | | YES | ignore |
| coordinates | | | | | | |

| Range bound | Explanation |
|---|---|
| maxnoofPosMeas | Maximum no. of measured quantities that can be configured |
| | and reported with one message. Value is 1638. |

### Obtaining the Position Information for a Group of UEs

A vehicle hosting the mobile IAB node may carry multiple UEs onboard, with a multitude of these UEs being served by the mobile IAB node. This means that all the UEs onboard are located at approximately the same position. Therefore, when knowing the position of one of the UEs indirectly indicates the position of other UEs onboard as well. The IAB-donor-CU serving the mobile IAB-DU knows the IDs of the UEs connected to the mobile IAB-DU (it is reasonable to assume all these UEs are likely all onboard the vehicle). Hence, if the LMF can obtain the position of one of the UEs onboard, it implicitly obtains the positions of other UEs onboard as well.

In one example, the NG-RAN node (e.g., the gNB) indicates to the LMF the list of UEs that are onboard the vehicle hosting the mobile IAB node and are connected to it. This information can be conveyed, e.g., together with the positioning information pertaining to one of the UEs onboard. In one variant, the information about other UEs onboard is requested by the LMF from the NG-RAN node. In another variant, the NG-RAN node provides this information by default, i.e., without being requested. In one variant, it is the AMF that provides this information to the LMF.

Furthermore, the AMF or the NG-RAN node may send updates to the LMF with respect to UEs leaving the vehicle, i.e., being handed over to another RAN node.

In one variant, the LMF may subscribe to the periodic updates of the position of the IAB-MT of the mobile IAB node. By being constantly updated about the position of the mobile IAB-MT, the LMF knows the position of all UEs onboard, without having to execute a dedicated positioning procedure for each UE.

In the above, the UEs may be identified by an existing identifier or by a newly introduced identifier.

The above can be achieved by enhancing the existing network signalling, or by defining dedicated signalling. An implementation example can use the NRPPa signalling as described above. Other signalling can be also used, such as F1AP, etc.

Now turning to FIG. 4, an exemplary method 200 in a first network node, such as the LMF (or gNB-CU), for communicating with a second network node, such as a mobile TRP, mobile gNB or mobile IAB node, will be described. At first, the LMF does not know if the TRP to which it is connected is a mobile TRP or static TRP. As such, method 200 comprises the following steps:
Step 210: sending a first message to the second network node for requesting a type of network node of the second network node;
Step 220: in response to the first message, receiving an indication of the type of network node of the second network node (e.g. TRP), the type of network node of the second network node being a mobile network node;
Step 230: send a second message to the second network node, the second message for requesting location information of the second network node based on the type of network node; and
Step 240: in response to the second message, receiving an indication of the location information from the second network node.

In some examples, the method receives positioning measurements from the second network node. In some examples, the method may determine a positioning error from the received positioning measurements. In some examples, the method may determine that the second network node is used for positioning assistance data when the positioning error is less than a threshold. In some examples, the method may exclude some positioning methods when the second network node is used for positioning assistance data. In some examples, the method may determine that the second network node is excluded for positioning assistance data when the positioning error is more than a threshold. In some examples, the method may send a third message to the second network node, the third message comprising instructions to the second network node to transmit PRS or perform RTOA measurements.

In some examples, the first message can be the same as the second message. In some examples, the second message can be a TRP INFORMATION REQUEST message. In some examples, the second message can be a request for location information as part of positioning measurements (e.g. POSITIONING MEASUREMENT REQUEST). In some examples, the first message can be one of a F1AP message and a NRPPa message. In some examples, the receipt of the indication of the type of network node can be received in a TRP INFORMATION RESPONSE message. In some examples, the receipt of the indication of the location information can be received in a TRP INFORMATION RESPONSE message. In some examples, the receipt of the indication of the location information can be received in a MEASUREMENT RESPONSE message. In some examples, the location information can comprise an indication of coordinates of the second network node. The location information can also comprise an indication of velocity of the second network node. In some examples, the first network node may receive, from the second network node, a list of cells or tracking areas where the second network node can move to. In some examples, the indication of the coordinates can be comprised in a TRP measurement Result (IE.

In some examples, the first network node may receive a list of UEs onboard of a vehicle served by the second network node. In some examples, a UE can be identified by an Identifier (ID), a new ID or an existing ID or an existing one that is modified. In some examples, the list of cell and tracking areas can be received in NRPPa or F1AP. In some examples, the method may receive a location or coordinates of the second network node as a positioning measurement in response to the second message. In some examples, the method may request a location of a first UE from the list to the second network node. In some examples, the method may receive the location of the first UE from the second node. In some examples, the method may determine the location of the rest of the UEs in the list based on the location of the first UE.

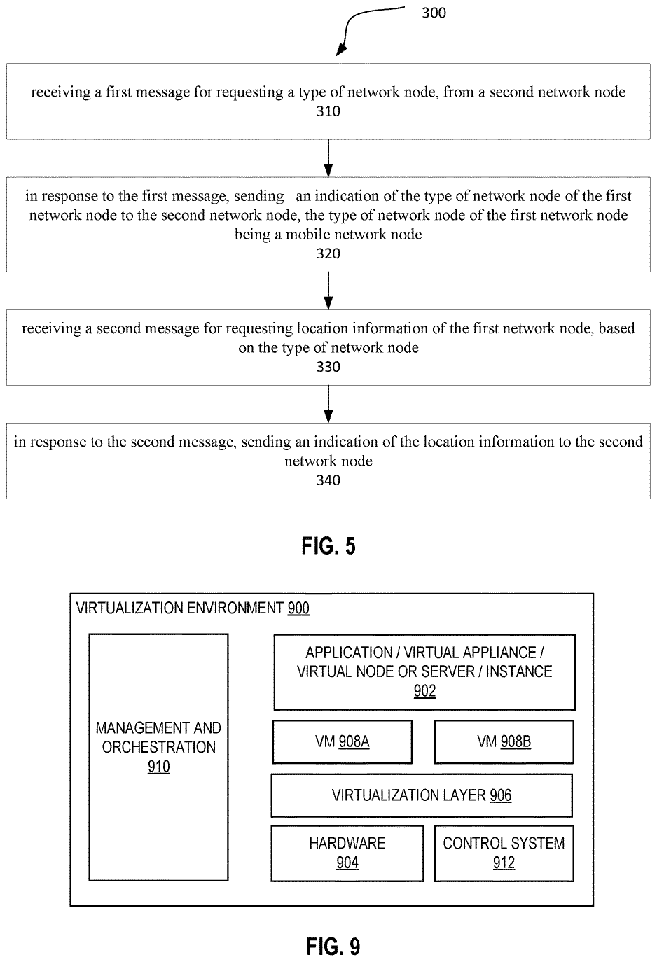

Now turning to FIG. 5, an exemplary method 300 in a first network node, such as a mobile TRP, mobile gNB or mobile IAB node for communicating with a second network node, such as the LMF, will be described. At first, the LMF does not know if the TRP to which it is connected is a mobile TRP or static TRP. As such, method 300 comprises the following steps:

Step 310: receiving a first message for requesting a type of network node, from a second network node;

Step 320: in response to the first message, sending an indication of the type of network node of the first network node to the second network node, the type of network node of the first network node being a mobile network node;

Step 330: receiving a second message for requesting location information of the first network node, based on the type of network node; and

Step 340: in response to the second message, sending an indication of the location information to the second network node.

In some examples, the first message can be the same as the second message. In some examples, the second message can be a TRP INFORMATION REQUEST. In some examples, the second message can be a request for location information as part of positioning measurements (e.g. POSITIONING MEASUREMENT REQUEST). In some examples, the first message can be one of a F1AP message and a NRPPa message. In some examples, the receipt of the indication of the type of network node can be received in a TRP INFORMATION RESPONSE. In some examples, the receipt of the indication of the location information can be received in a TRP INFORMATION RESPONSE. In some examples, the receipt of the indication of the location information can be received in a MEASUREMENT RESPONSE and MEASUREMENT REPORT. In some examples, the location information can comprise an indication of coordinates of the first network node. The coordinates can be sent as a positioning measurement, for example. The location information can also comprise an indication of velocity of the first network node. In some examples, the first network node may receive, from the second network node, a list of cells or tracking areas where the first network node can move to. In some examples, the indication of the coordinates can be comprised in a TRP measurement Result IE. In some examples, the second network node may send a list of UEs onboard of a vehicle served by the first network node. In some examples, a UE can be identified by an Identifier (ID), an existing UE ID or a modified existing UE ID. In some examples, the first network node may perform positioning measurements and send them to the second network node. In some examples, the method may receive a third message, the third message comprising instructions to the first network node to transmit PRS or perform Relative time of Arrival (RTOA) measurements. In some examples, the list of cells and tracking areas can be sent in NRPPa or F1AP. In some examples, the method may further receive a request of a location of a first UE from the list to the second network node. In some examples, the method may further send the location of the first UE to the second node.

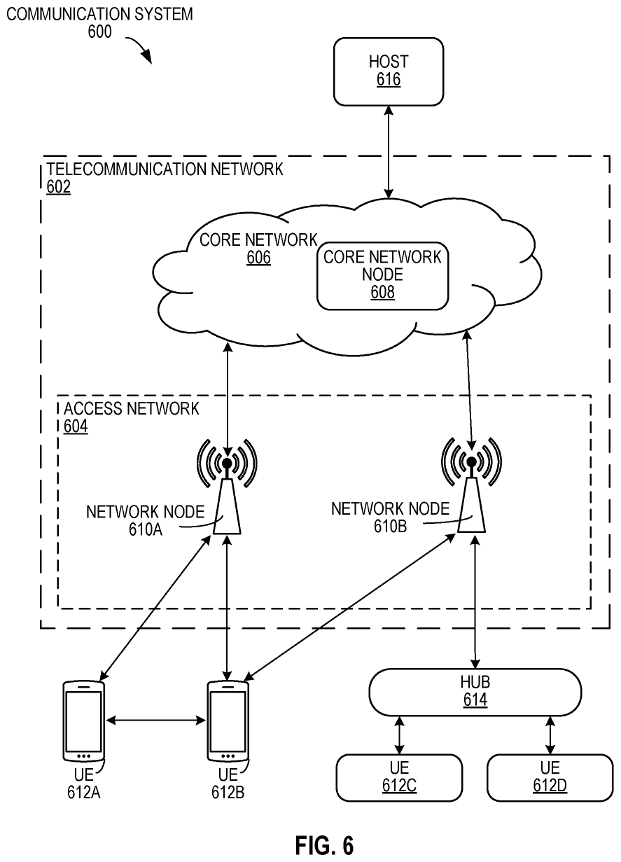

FIG. 6 shows an example of a communication system 600 in accordance with some embodiments.

In the example, the communication system 600 includes a telecommunication network 602 that includes an access network 604, such as a radio access network (RAN), and a core network 606, which includes one or more core network nodes 608. The access network 604 includes one or more access network nodes, such as network nodes 610a and 610b (one or more of which may be generally referred to as network nodes 610), or any other similar 3GPP access node or non-3GPP access point. The network nodes 610 facilitate direct or indirect connection of UE, such as by connecting UEs 612a, 612b, 612c, and 612d (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF), LMF, etc.

The host 616 may be under the ownership or control of a service provider other than an operator or provider of the access network 604 and/or the telecommunication network 602, and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 602 is a cellular network that implements 3GPP standardized features. Accordingly, the telecommunications network 602 may support network slicing to provide different logical networks to different devices that are connected to the telecommunication network 602. For example, the telecommunications network 602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single- or multi-RAT or multi-standard mode. For example, a UE may operate with any one or combination of Wi-Fi, NR and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 614 communicates with the access network 604 to facilitate indirect communication between one or more UEs (e.g., UE 612c and/or 612d) and network nodes (e.g., network node 610b). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a VR headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular in if one or more of the UEs are low energy IoT devices.

The hub 614 may have a constant/persistent or intermittent connection to the network node 610b. The hub 614 may also allow for a different communication scheme and/or schedule between the hub 614 and UEs (e.g., UE 612c and/or 612d), and between the hub 614 and the core network 606. In other examples, the hub 614 is connected to the core network 606 and/or one or more UEs via a wired connection. Moreover, the hub 614 may be configured to connect to an M2M service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610b. In other embodiments, the hub 614 may be a non-dedicated hub—that is, a device which is capable of operating to route communications between the UEs and network node 610b, but which is additionally capable of operating as a communication start and/or end point for certain data channels.

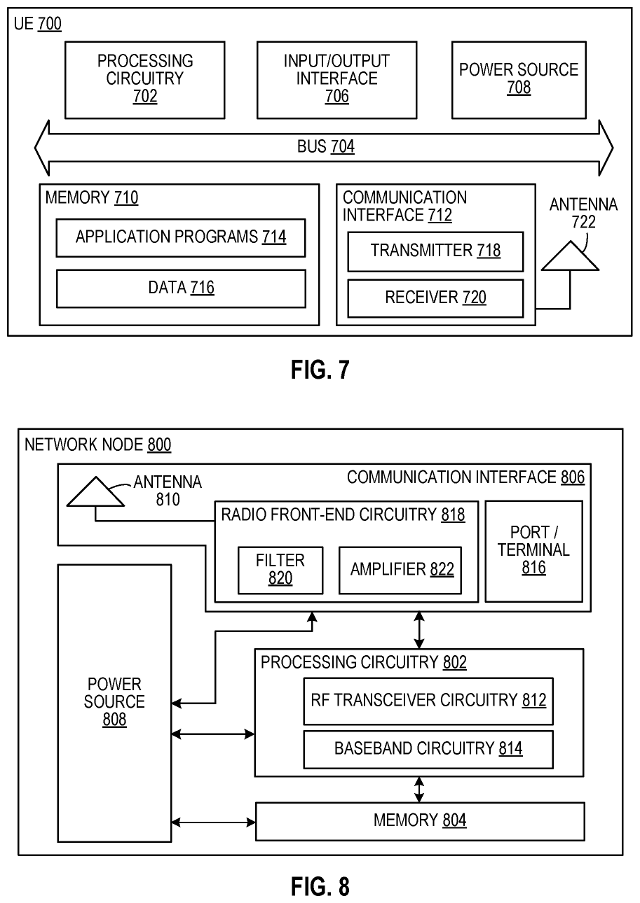

FIG. 7 shows a UE 700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3GPP, including a narrow band internet of things (NB-IoT) UE, a machine type communication (MTC) UE, and/or an enhanced MTC (eMTC) UE.

The UE QQ700 includes processing circuitry QQ702 that is operatively coupled via a bus QQ704 to an input/output interface QQ706, a power source QQ708, a memory QQ710, a communication interface QQ712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 702 may include multiple central processing units (CPUs).

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging of the power source 708. Power circuitry may perform any formatting, converting, or other modification to the power from the power source 708 to make the power suitable for the respective components of the UE 700 to which power is supplied.

The memory 710 may be or be configured to include memory such as random access memory (RAM), read-only memory (ROM), programmable ROM (PROM), erasable PROM (EPROM), electrically EPROM (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., antenna 722) and may share circuit components, software or firmware, or alternatively be implemented separately.

FIG. 8 shows a network node 800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (Aps) (e.g., radio access points), base stations (BSs) (e.g., radio base stations, Node Bs (NBs), evolved NBs (eNBs) and NR NBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes a processing circuitry 802, a memory 804, a communication interface 806, and a power source 808. The network node 800 may be composed of multiple physically separate components (e.g., a NodeB component and a RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple NBs. In such a scenario, each unique NB and RNC pair, may in some instances be considered a single separate network node. In some embodiments, the network node 800 may be configured to support multiple radio access technologies (RATs). In such embodiments, some components may be duplicated (e.g., separate memory 804 for different RATs) and some components may be reused (e.g., a same antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 800. As a note, a core network node has similar components as network node 800. Therefore, the description provided to the network node 800 is also valid for a core network node.

The processing circuitry 802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 800 components, such as the memory 804, to provide network node 800 functionality. For example, the processing circuitry 802 is configured to perform any actions/operations/blocks of method 200 of FIG. 4, when the first network node is a LMF and method 300 of FIG. 5 when the first network node is a mobile TRP/mobile IAB/mobile gNB.

In some embodiments, the processing circuitry 802 includes a system on a chip (SOC). In some embodiments, the processing circuitry 802 includes one or more of radio frequency (RF) transceiver circuitry 812 and baseband processing circuitry 814. In some embodiments, the radio frequency (RF) transceiver circuitry 812 and the baseband processing circuitry 814 may be on separate chips (or sets of chips), boards, or units, such as radio units and digital units. In alternative embodiments, part or all of RF transceiver circuitry 812 and baseband processing circuitry 814 may be on the same chip or set of chips, boards, or units.

The memory 804 may comprise any form of volatile or non-volatile computer-readable memory including, without limitation, persistent storage, solid-state memory, remotely mounted memory, magnetic media, optical media, random access memory (RAM), ROM, mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and memory 804 is integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. Radio front-end circuitry 818 comprises filters 820 and amplifiers 822. The radio front-end circuitry 818 may be connected to an antenna 810 and processing circuitry 802. The radio front-end circuitry may be configured to condition signals communicated between antenna 810 and processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of filters 820 and/or amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface may comprise different components and/or different combinations of components.

In certain alternative embodiments, the network node 800 does not include separate radio front-end circuitry 818, instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes one or more ports or terminals 816, the radio front-end circuitry 818, and the RF transceiver circuitry 812, as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, communication interface 806, and/or the processing circuitry 802 may be configured to perform any receiving operations and/or certain obtaining operations described herein as being performed by the network node. Any information, data and/or signals may be received from a UE, another network node and/or any other network equipment. Similarly, the antenna 810, the communication interface 806, and/or the processing circuitry 802 may be configured to perform any transmitting operations described herein as being performed by the network node. Any information, data and/or signals may be transmitted to a UE, another network node and/or any other network equipment.

The power source 808 provides power to the various components of network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid, an electricity outlet) via an input circuitry or interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

FIG. 9 is a block diagram illustrating a virtualization environment 900 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 902 (which may alternatively be called software instances, virtual appliances, network functions, virtual nodes, virtual network functions, etc.) are run in the virtualization environment 900 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or virtual machine monitors (VMMs)), provide VMs 908a and 908b (one or more of which may be generally referred to as VMs 908), and/or perform any of the functions, features and/or benefits described in relation with some embodiments described herein. The virtualization layer 906 may present a virtual operating platform that appears like networking hardware to the VMs 908.

The VMs 908 comprise virtual processing, virtual memory, virtual networking or interface and virtual storage, and may be run by a corresponding virtualization layer 906. Different embodiments of the instance of a virtual appliance 902 may be implemented on one or more of VMs 908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 908 may be a software implementation of a physical machine that runs programs as if they were executing on a physical, non-virtualized machine. Each of the VMs 908, and that part of hardware 904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 908 on top of the hardware 904 and corresponds to the application 902.

Hardware 904 may be implemented in a standalone network node with generic or specific components. Hardware 904 may implement some functions via virtualization. Alternatively, hardware 904 may be part of a larger cluster of hardware (e.g. such as in a data center or CPE) where many hardware nodes work together and are managed via management and orchestration 910, which, among others, oversees lifecycle management of applications 902. In some embodiments, hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 912 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The above-described embodiments are intended to be examples only. Alterations, modifications and variations may be effected to the particular embodiments by those of skill in the art without departing from the scope of the description.

What is claimed is:

1. A method performed by a first network node, the method comprising:
sending a first message to a second network node, for requesting a type of network node of the second network node;
in response to the first message, receiving an indication of the type of network node of the second network node, the type of network node of the second network node being a mobile network node;
sending a second message to the second network node, for requesting location information of the second network node, based on the type of network node; and
in response to the second message, receiving an indication of the location information from the second network node.

2. The method of claim 1, wherein the first message is the same as the second message.

3. The method of claim 1 or 2, wherein the second message is a TRP INFORMATION REQUEST message.

4. The method of claim 1 or 2, wherein the second message is a request for location information as part of positioning measurements.

5. The method of any one of claims 1 to 4, wherein the first message is one of a F1AP message and a NRPPa message.

6. The method of any one of claims 1 to 5, wherein the receipt of the indication of the type of network node is received in a TRP INFORMATION RESPONSE message.

7. The method of any one of claims 1 to 6, wherein the receipt of the indication of the location information is received in a TRP INFORMATION RESPONSE message.

8. The method of any one of claims 1 to 6, wherein the receipt of the indication of the location information is received in a MEASUREMENT RESPONSE message.

9. The method of any one of claims 1 to 8, wherein the location information comprises an indication of coordinates of the second network node.

10. The method of any one of claims 1 to 9, wherein the location information comprises an indication of velocity of the second network node.

11. The method of any one of claims 1 to 10, further comprising receiving, from the second network node, a list of cells or tracking areas where the second network node can move to.

12. The method of claim 9, wherein the indication of the coordinates is comprised in a TRP measurement Result Information Element (IE).

13. The method of any one of claims 1 to 12, further comprising receiving a list of User Equipment (UEs) onboard of a vehicle served by the second network node.

14. The method of any one of claims 1 to 13, wherein a UE is identified by an Identifier (ID).

15. A method performed by a first network node, the method comprising:
receiving a first message for requesting a type of network node, from a second network node;
in response to the first message, sending an indication of the type of network node of the first network node to the second network node, the type of network node of the first network node being a mobile network node;
receiving a second message for requesting location information of the first network node, based on the type of network node; and
in response to the second message, sending an indication of the location information to the second network node.

16. The method of claim 15, wherein the first message is the same as the second message.

17. The method of claim 15 or 16, wherein the second message is a TRP INFORMATION REQUEST.

18. The method of claim 15 or 16, wherein the second message is a request for location information as part of positioning measurements.

19. The method of any one of claims 15 to 18, wherein the first message is one of a F1AP message and a NRPPa message.

20. The method of any one of claims 15 to 19, wherein the receipt of the indication of the type of network node is received in a TRP INFORMATION RESPONSE.

21. The method of any one of claims 15 to 20, wherein the receipt of the indication of the location information is received in a TRP INFORMATION RESPONSE.

22. The method of any one of claims 15 to 21, wherein the receipt of the indication of the location information is received in a MEASUREMENT RESPONSE and MEASUREMENT REPORT.

23. The method of any one of claims 15 to 22, wherein the location information comprises an indication of coordinates of the first network node.

24. The method of any one of claims 15 to 23, wherein the location information comprises an indication of velocity of the first network node.

25. The method of any one of claims 15 to 24, further comprising receiving, from the second network node, a list of cells or tracking areas where the first network node can move to.

26. The method of claim 23, wherein the indication of the coordinates is comprised in a TRP measurement Result Information Element (IE).

27. The method of any one of claims 15 to 26, further comprising sending a list of User Equipment (UEs) onboard of a vehicle served by the first network node.

28. The method of any one of claims 15 to 27, wherein a UE is identified by an Identifier (ID).

29. A network node, comprising processing circuitry and a network interface connected thereto, the processing circuitry configured to perform any one of the methods of any one of claims 1 to 28.

30. A computer program product comprising a computer readable memory storing computer executable instructions thereon that when executed by a computer perform any one of the methods of any one of claims 1 to 28.
